(19) United States
(12) Patent Application Publication
(10) Pub. No.: US 2025/0173801 A1
(43) Pub. Date: May 29, 2025

(54) SYSTEM AND METHODS FOR SECURING CERTAIN COMMUNICATIONS

(71) Applicant: JIMMY DORSEY REAL ESTATE, LLC, Happy Valley, OR (US)

(72) Inventor: Ryan James Dorsey, Happy Valley, OR (US)

(73) Assignee: JIMMY DORSEY REAL ESTATE, LLC, Happy Valley, OR (US)

(21) Appl. No.: 18/839,630

(22) PCT Filed: Mar. 7, 2023
(86) PCT No.: PCT/US2023/063810

§ 371 Date: Aug. 19, 2024

Related U.S. Application Data
(60) Provisional application No. 63/317,542, filed on Mar. 8, 2022.

(51) Int. Cl. G06Q 50/16; H04L 9/40

(52) U.S. Cl. CPC G06Q 50/16; H04L 63/0428; H04L 63/083

(57) ABSTRACT

Secure and privatized chat communication system (and related methods) for participants relating to a particular potential estate transaction, comprising: a software application for a mobile smartphone enabling registration of brokers/realtors, potential buyers, sellers, owners, and neighbors, regarding the particular real estate sales transaction, wherein blockchain secured wallets are issued, roles such as administrator, broker/realtor, customer, and user, are assigned by administrators, and user credentials, such as neighbor, owner, buyer, and seller, users, wherein the user credentials are issued by selected brokers/realtors registered with the system, for verifying the user's authenticity, to further support and enable secure, peer-to-peer chat communications between users of the system.

This is a PCT patent application which claims the benefit and priority of U.S. Provisional Patent Application Ser. No. 63/317,542, filed Mar. 8, 2022.

### TECHNICAL FIELD

The present invention relates to electronic systems and methods for securing communications facilitating real estate transactions, and more particularly to a system and method for securing communications facilitating real estate transactions so as to provide secure, validated, and private communications between neighbors of buyers and sellers and between buyers, sellers, owners, realtors, and others, related to the real estate transaction.

### BACKGROUND ART

Currently, real estate transactions do not allow buyers and sellers to communicate in a secure way so that they may learn about factors that would have an effect on their quality of life. People search deep into real estate sites trying to find context for what their quality of life could be like in a new home, but they are not able to find it. Rather, all that today's sites provide are houses, and houses alone cannot provide enough information to determine a quality of life—this is dependent on relationships. Thus, people should be found on real estate sites, and neighbors should be able to connect to potential neighbors as part of a real estate sale transaction.

The evolution of the World Wide Web from its inception to the present day has shifted from static, read-only web pages to interactive, user-generated content and now towards a decentralized, intelligent network. Authentication, the process of verifying the identity of a user, has undergone significant changes with each iteration of the web as well.

In the early days of the web, authentication was a simple process of logging in with a username and password, without much consideration for security. With the advent of social media and e-commerce sites, authentication became more critical. Websites started using SSL/TLS protocols for secure data transmission, two-factor authentication, and captchas to prevent automated attacks.

However, the web still faces significant challenges regarding authentication, such as single points of failure, weak password management, and data breaches. Future web technology, focusing on decentralization, aims to tackle these issues by implementing blockchain technology and decentralized identifiers (DIDs) that put users in control of their data and identities. This approach promises to provide more robust and secure authentication, eliminating the need for traditional login credentials (such as passwords) and ensuring data privacy.

Overall, the web evolution has seen significant advancements in authentication, from simple username and password combinations to blockchain-based identity verification systems, and this technology will greatly impact the future of online authentication.

### SUMMARY OF INVENTION

In accordance with an aspect and embodiment of the disclosure, there is provided a computerized system for enabling secure communications between system users regarding a subject property of a specific anticipated real estate transaction. The system is adapted for accessing and using a known blockchain decentralized identifier (DID) network for confirming the users' identities, and the system is further adapted for accessing and using a known mediator subsystem network on the Internet for the receiving of chat messages and the delivery of chat messages.

The system comprises: a software application for download to users' mobile smartphones, and the system comprises a module for enabling registration of realtor users and other users, thus enabling use and storage of a username and a password for each user. The system also enables the creation and use of a digital wallet for allowing revocable authentication of users' access to the system using the DID network. Further, the software application comprises another module for enabling realtor users to issue and revoke credentials to other users as one or more of, a bona fide neighbor, a bona fide owner, a bona fide potential buyer, and a bona fide seller, of the subject property of the anticipated real estate transaction.

The system further comprises a host server computer system having a module for validating the realtor users and the other users' login user identifications and passwords to enable opening of said software application by the users on their mobile smartphones to enable the opening of the users' digital wallets on their mobile smartphones, wherein the module of said host server computer system thereby also enables the realtor users to use the another module of said software application on their mobile smartphones to issue and revoke the credentials.

The software application further comprises yet another module for enabling the users, both realtor users and other users, to create chat invites, for the users to accept the chat invites, and to thus enable the users to chat peer-to-peer with one another, wherein the chats are communicated asynchronously via the mediator subsystem network on the Internet, and wherein the chats are secured since the users have logged in to the software application on their smartphones and their identities have already been confirmed via their blockchain-secured wallets on the DID network.

In accordance with an aspect and embodiment of the disclosure, the system enables realtor users to identify and verify other users relating to a particular real estate transaction and to provide a credential to the users' digital wallets, thus confirming to the system, and hence visually confirming to other users associated with the real estate transaction, that the user is a bona fide neighbor, for example, of the subject property of the specific anticipated real estate transaction.

Similarly, as the case may require, the system also enables realtor users to follow a similar process to that described above to provide other credentials to user's digital wallets, thus confirming to the system, and hence visually confirming to other users associated with the real estate transaction, that the user is one of a bona fide potential buyer of the subject property of the specific anticipated real estate transaction, a bona fide owner of the subject property, or a bona fide seller of the subject property.

In this way, users of the secure and privatized chat feature of the system are enabled in seeing confirmation of just who it is they are chatting securely with, and what relationship they have with the subject property.

In accordance with another aspect and embodiment of the disclosure, there is provided a method of authenticating users and issuing of credentials pertaining to a subject property of a specific anticipated real estate transaction, the method being adapted for accessing and using a blockchain decentralized identifier (DID) network for confirming the users' identities. The method, in no particular order of importance except as necessary to carry out the steps of the method, comprises the steps of:
providing a software application for users to download and install on their mobile smartphones;
accessing a host server network with a software application module for verifying at least one of a valid email address or a valid phone number of each user;
registering each verified user on a host server computer system;
issuing a blockchain secured digital wallet to each user's smartphone;
creating in the user's digital wallet a revocable authentication for use in verifying a user's identity, enabling granting of trusted status, and replicating the user's public digital identity to be publicly available in the distributed ledger on the DID network; and
enabling issuing of a credential by a realtor user to the digital wallet of another user of one or more of, a bona fide neighbor, a bona fide owner, a bona fide buyer, or a bona fide seller, as to the subject property of the specific anticipated real estate transaction.

In accordance with an aspect of the disclosure, the method is further adapted for inviting secure and privatized chat messaging between the authenticated and credentialed users, the method being further adapted for accessing and using a mediator subsystem network on the Internet for the receiving of chat messages and the delivery of chat messages. This aspect of the method, in no particular order of importance except as necessary to carry out the steps of the method, comprises the steps of:
enabling creation of a chat request invitation from a first user to a second user;
submitting to the mediator subsystem network the chat request invitation together with the first user's public digital identity and directed to the public digital identity of the second user; and
listening for an acceptance of the request invitation and indicating the second user as available for chat.

In accordance with an aspect of the disclosure, the method is further adapted for receiving and responding to a chat request invitation, between the authenticated and credentialed users, the method being further adapted for accessing and using a mediator subsystem network on the Internet for the receiving of chat messages and the delivery of chat messages. This aspect of the method, in no particular order of importance except as necessary to carry out the steps of the method, comprises the steps of:
checking the mediator subsystem network, downloading, and displaying any available chat request invitations;
enabling acceptance or denial of a chat request invitation, comprising submitting to the mediator subsystem network the second user's acceptance, together with the second user's public digital identity and directed to the public digital identity of the first user; and
listening for an acceptance of the request invitation and indicating the second user as available for chat.

The method, or methods hereof combined, provide peer-to-peer asynchronous chat communication freely enabled between users, e.g., a first user and a second user, on their mobile smartphone software applications. The method may provide that the first user's chat invitation request may optionally include the name of the first user. Further, the method may provide that the first user's chat invitation request may optionally include the address of the first user.

Still further, the method may provide that the second user's chat acceptance may optionally include the name of the second user. Yet further, the method may provide that the second user's chat acceptance may optionally include the address of the second user.

In accordance with an aspect of the disclosure, the method provides that the chat messages are secure and privatized using the user's private and public keys. In one embodiment, this means that the users are known to the system to actually be, as shown by their credential issued by the realtor user, one of a bona fide neighbor, a bona fide potential buyer, a bona fide seller, or a bona fide owner of a subject property of a particular real estate transaction, all as may be verified by a realtor user having an interest in the success of the real estate transaction. The users have control over whether they communicate or not (by accepting or not accepting a chat invitation request), their personal public identities may be shielded, but at a minimum they are verified as having a bona fide relationship, as suggested by their credential issued by the realtor, to the subject property, and as is verifiably authentic as secured by private and public keys using the distributed ledger on the decentralized identifier network.

In accordance with another aspect and embodiment of the disclosure, the method and system may provide that the content of chat messages themselves in the system may be encrypted by the private key of the user sending a particular chat message and decrypted by the public key of the user sending the chat message.

The system and method of the disclosure provide for authenticating peer-to-peer communication between users relating to real estate transactions using the decentralized identifier (DID) network and the mediator subsystem network. This, in turn, leverages the decentralized and immutable nature of blockchain technology to provide a secure and transparent authentication process for home buyers, sellers, owners, and neighbors. This technology allows buyers, sellers, owners, and neighbors to interact with each other as verified participants via the DID network and the mediator subsystem network to secure and privatize peer-to-peer chat between users of the system and method. Alternatively, the system and method of the disclosure may allow for verifying authenticity of some participants, such as for example neighbors, without disclosing any of their private information (e.g., without their name or address), since user-IDs may be used as zero-knowledge proof by the system on the distributed ledger to verify and authenticate bona fide users without disclosing their identity.

The system and methods disclosed provide an extra layer of security to the entire process and the confidence that a user is communicating with verified users as they are investigating a potential real estate transaction. A possible use of this technology may be that it may allow for a subscription-based business model relative to realtors and users in various markets, wherein users pay a fee (monthly or one-time fee) to use the application, and it may enable users to establish social media-type accounts.

Other uses for the application pertaining to real estate-related transactions may include the following: offering a piece of real estate for sale on the market (with a verified seller and owner), coordinating and scheduling a photo session of a property, listing real estate for sale on the system (which may also be listed on a multiple listing service (MLS)), tracking and exchanging documents related to the sale of property, communication between seller and potential buyer, such as scheduling a showing, allowing a buyer to enter and document an offer to a seller to buy a property, allowing a seller to accept and document an acceptance of an offer to buy, scheduling a home inspection, or scheduling a closing.

The subject matter of the present invention is particularly pointed out and distinctly claimed in the concluding portion of this specification. However, both the organization and method of operation, together with further advantages and objects thereof, may best be understood by reference to the following descriptions taken in connection with accompanying drawings wherein like reference characters refer to like elements.

### BRIEF DESCRIPTION OF DRAWINGS

FIG. 1A is an illustration of a wireless cellular network enabling download of an Android-based Real Estate Mobile Application (also hereafter referred to as an REM Application, or an REM App) smart phone mobile application for implementing a system and methods in accordance with the present disclosure;

FIG. 1B is an illustration of a wireless cellular network enabling download of an Apple IOS-based Real Estate Mobile Application (also hereafter referred to as an REM Application, or REM App) smartphone mobile application for implementing a system and methods in accordance with the present disclosure;

FIG. 2A is a high-level illustration of a system for enabling secure communications relating to a real estate transaction;

FIG. 2B is an illustration of an interface between a PC and a host server system via JavaScript for administration of the host server system, and also of an interface between mobile devices, having REM Applications thereon, for enabling access to client applications for implementing the system and method of the present disclosure via a cellular phone network, WIFI, and/or the Internet;

FIG. 3 is an illustration of a host server system and back-end administrator client for allowing administrator access to manage host server functions such as user authorization (i.e., login to the host server system), photo management (e.g., photos of properties for sale or users) and a customer relationship management database, including properties, users, activities, and buyers;

FIGS. 4A and 4B are flow charts illustrating the signup process, validation of user identity, and upon validation the creation of a blockchain wallet on a user's mobile phone with a corresponding entry into a distributed ledger for authenticating user identity;

FIG. 5 is an architecture diagram illustrating an authentication system for authenticating users to establish trust as pertaining to a real estate transaction, comprising a mobile application accessing a user's wallet for connecting to a blockchain node Decentralized Identifier (DID) network which replicates a distributed ledger on each node of the network;

FIG. 6 is an illustration of a DID authenticated (as per FIG. 5) entrusted administrator, using a management application to identify, verify, and assign one or more roles to one or more users listed on the host server, such as a verified Administrator, verified Broker/Realtor, verified Customer, and/or verified User, relating to a real estate transaction listing;

FIG. 7 is an illustration of a DID authenticated (as per FIG. 5) realtor, using the REM App to view a particular customer to add credentials to that customer's user account;

FIG. 8 is an illustration of the DID authenticated (as per FIG. 5) realtor using the REM App to issue one or more credentials, comprising Neighbor, Buyer, Owner, Seller, to the particular customer's user account in order to provide them with a “VERIFIED” badge when they appear to others in the system;

FIG. 9 is an illustration of the DID authenticated (as per FIG. 5) realtor's view of the verified customer's account information after the credentials have been issued per the process associated with FIG. 8;

FIG. 10 is an illustration of a DID authenticated (as per FIG. 5) potential buyer having entered an address, zipcode, or MLS number, search to see available properties on a map around the area of the search, together with pricing information for each of the properties;

FIG. 11 is an illustration of a detailed screen visible to the DID authenticated (as per FIG. 5) potential buyer upon clicking on one of the available properties as per FIG. 10, together with a button allowing the potential buyer to “Check Out The Neighbors”;

FIG. 12 is an illustration of a chat screen visible to the DID authenticated potential buyer upon clicking on the button to “Check Out the Neighbors”, as per FIG. 11, allowing the potential buyer to select for chat, or to press another button to invite to chat, with a particular neighbor about the chosen property for sale (as chosen per FIGS. 10 and 11) and also having a user account on the system, as a precursor to a potential real estate transaction for the chosen property;

FIG. 13 is an illustration of a chat screen, along with confidential peer-to-peer communications, visible to the DID authenticated potential buyer after having selected a particular neighbor for chat (per FIG. 12), showing the potential buyer that the neighbor selected has been verified by a DID authenticated realtor (per FIG. 8) associated with the property selected on the map (per FIG. 10);

FIG. 14 is an illustration of a DID authenticated realtor accessing the customer relationship management database to confirm that a particular buyer is a verified buyer (meaning they have been verified as an account holder in the system and are working with a verified realtor of the system), as verified by the badge at the top of the screen and the credential listed at the bottom of the screen;

FIG. 15 is an illustration of a DID authenticated potential buyer having pressed a filter button on an REM App map screen (as per FIG. 10), allowing the potential buyer to enter and apply specific filters (such as number of bedrooms, baths, square footage, price, etc.) enabling showing of only those properties for sale shown on the map of the system and which qualify given the applied filters;

FIG. 16 is an illustration of a screen made available to the DID authenticated potential buyer of FIG. 15 after having selected one of the properties shown for sale on the map of the system, the screen showing the potential buyer that the property selected is offered by a seller that is also indicated as a Verified seller, meaning that the seller has been given credentials by a realtor also associated with the system;

FIG. 17 is an illustration of a screen made available to the DID authenticated potential buyer after having selected the “Chat” button at the bottom of the REM App, showing that the Verified seller and Verified Owner are also available for the chat feature of the REM App;

FIG. 18 is an architecture-type illustration of a security-enabled authentication that takes place to allow one chat user (e.g., a potential buyer), to securely communicate with another chat user (e.g., a neighbor), wherein each chat participant is directly authenticated using the blockchain, apart from being authenticated via the host server system, to provide secure peer-to-peer communication between these two users;

FIG. 19 is an illustration of architecture of a secure peer-to-peer chat subsystem that enables chats to take place between two users (e.g., the same users as shown in FIG. 18) via a mediator subsystem network on the Internet, without being re-authenticated via the host server system (it being the case that the chat participants are authenticated via the host server when they log into their respective smartphone applications); and

FIG. 20 is a unified modeling language (UML) sequence diagram illustrating the timing and actors for authentication of users and forwarding of chat messages between them via the host DID network and the mediator subsystem network, respectively.

### DESCRIPTION OF EMBODIMENTS

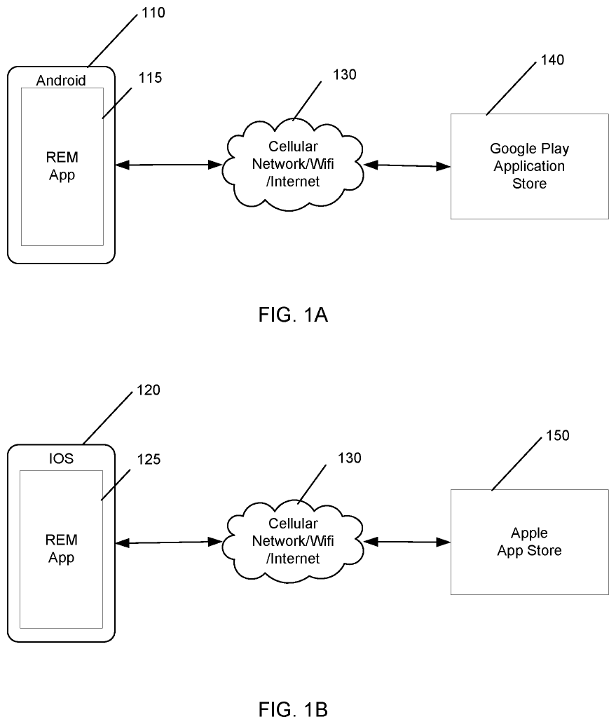

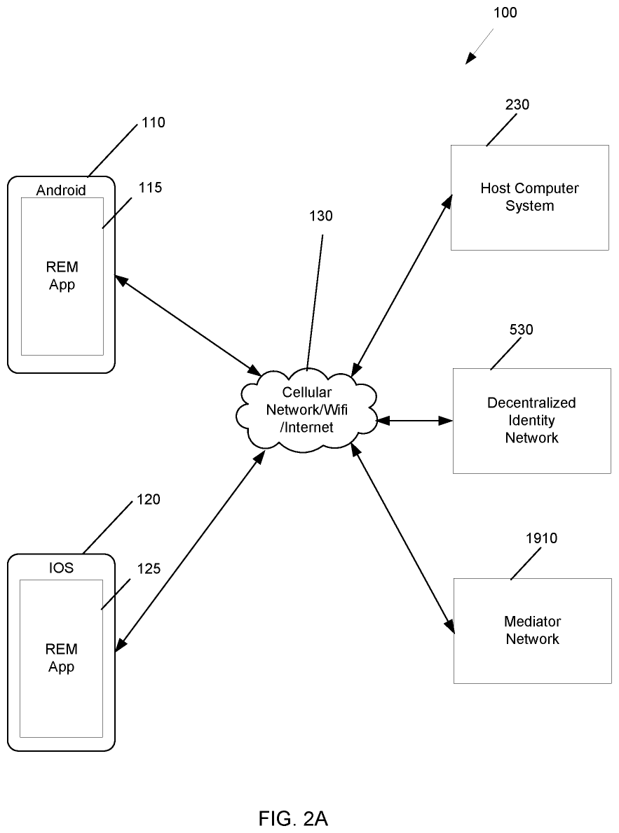

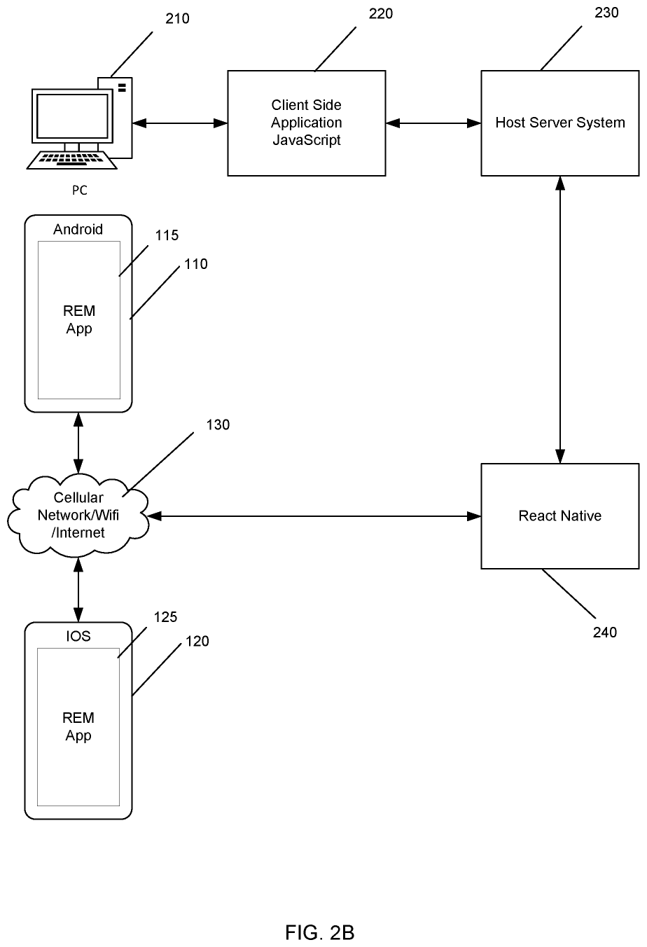

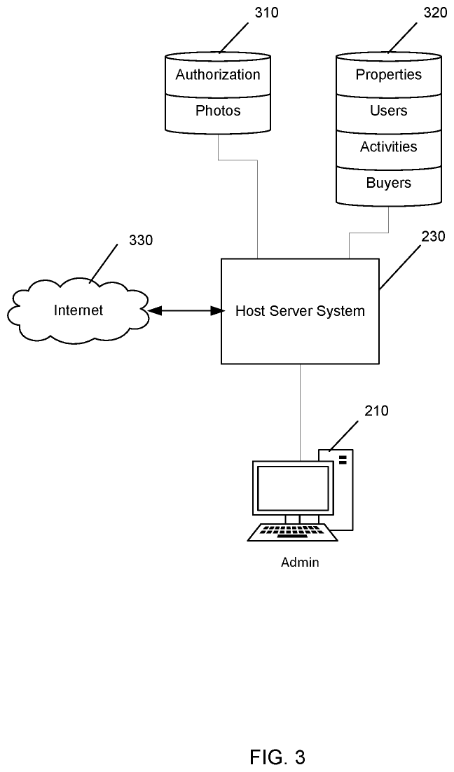

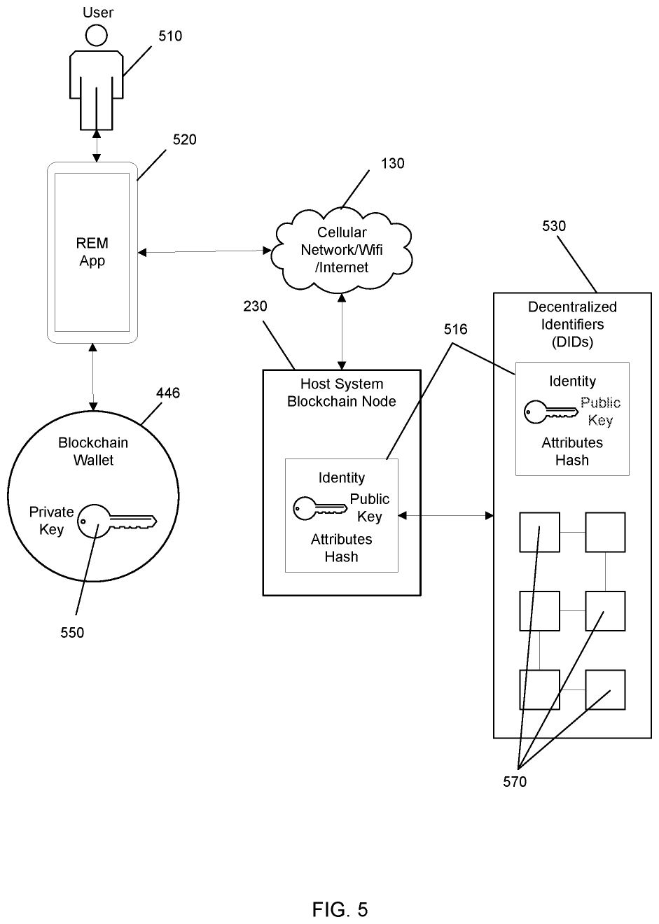

Referring to FIGS. 1-20, in accordance with one or more aspects and an embodiment of the disclosure, there is provided a computerized system 100 (see FIG. 2A), and related methods as described herein, for enabling secure communications between system users (e.g., user 510 of FIG. 5) using their smartphones (e.g., smart phones 110, 120, 520, 1815, 1855).

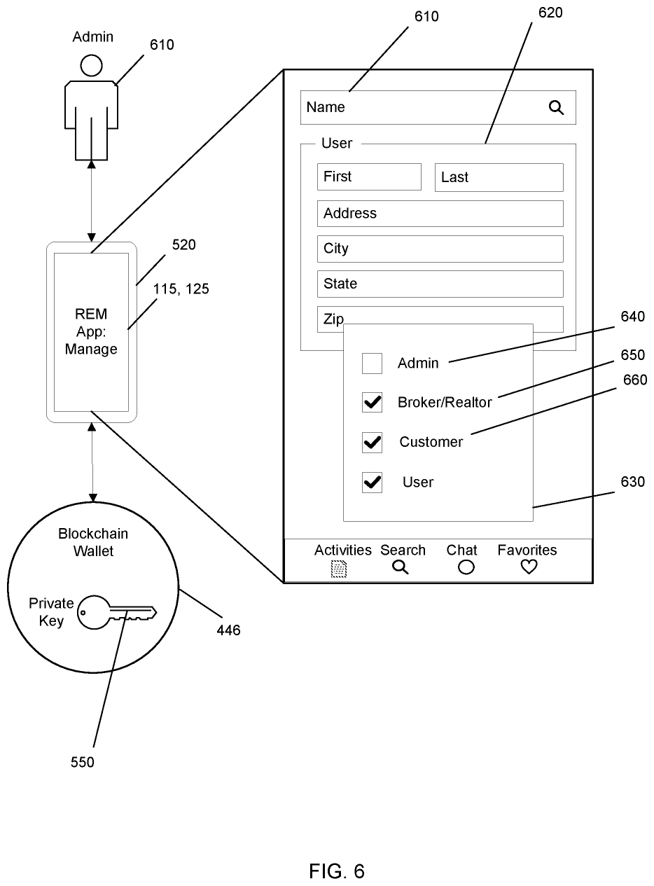

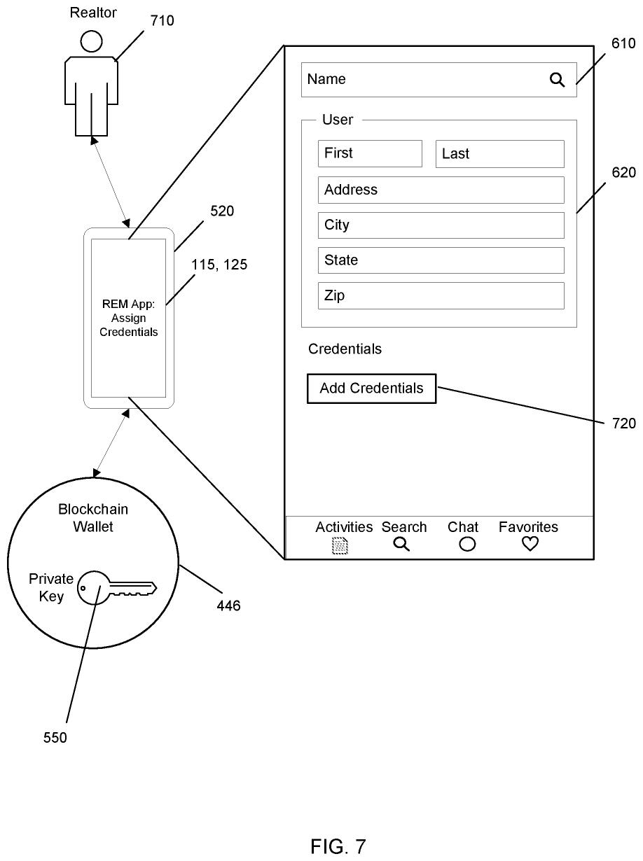

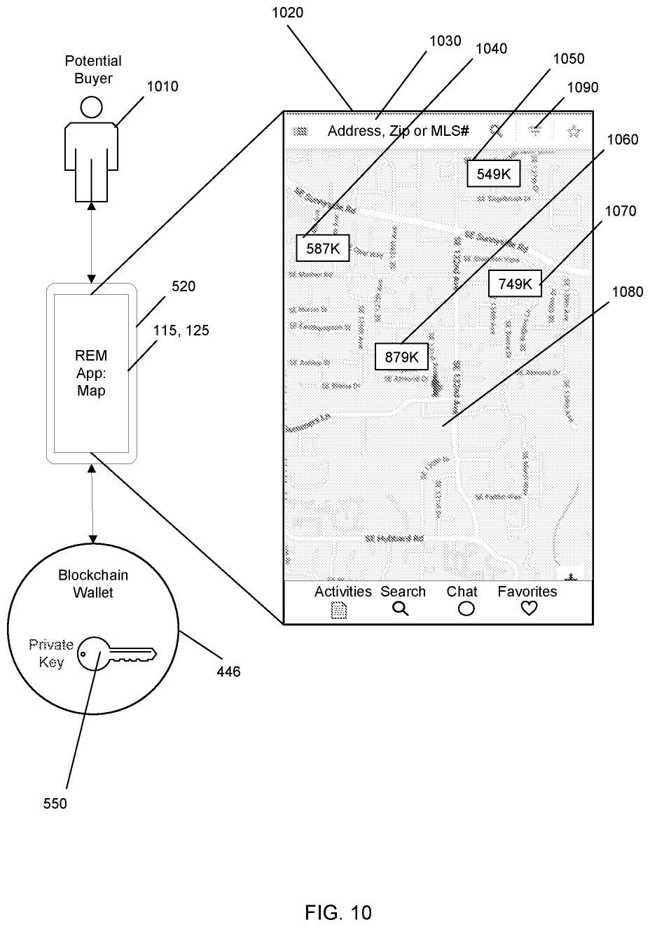

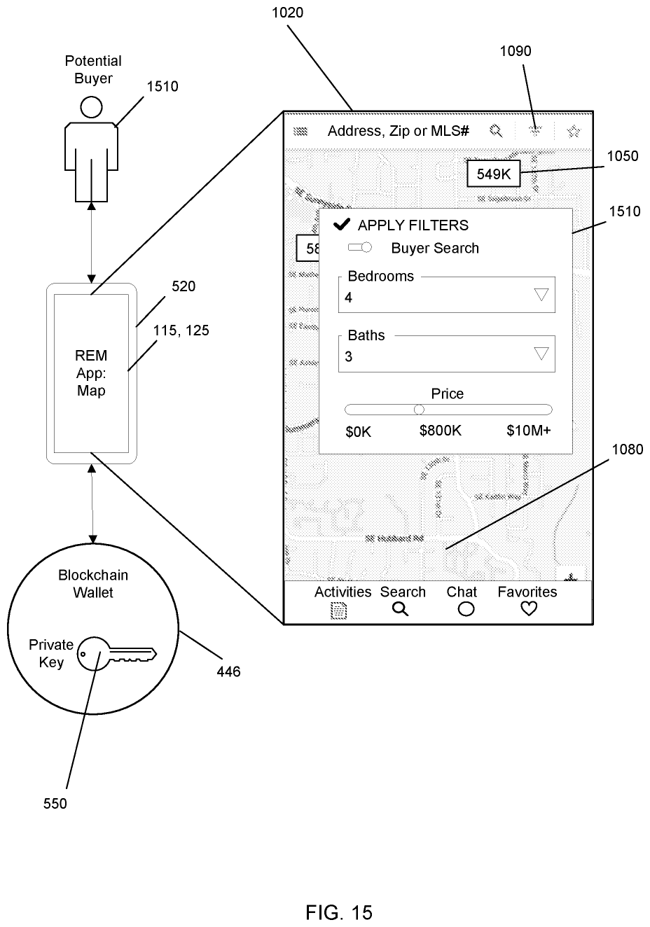

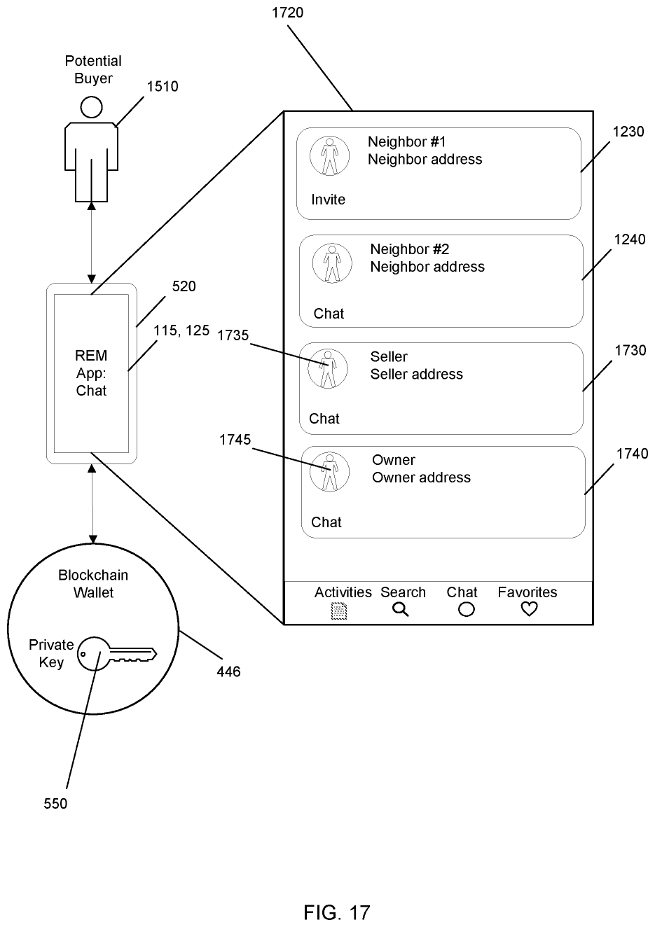

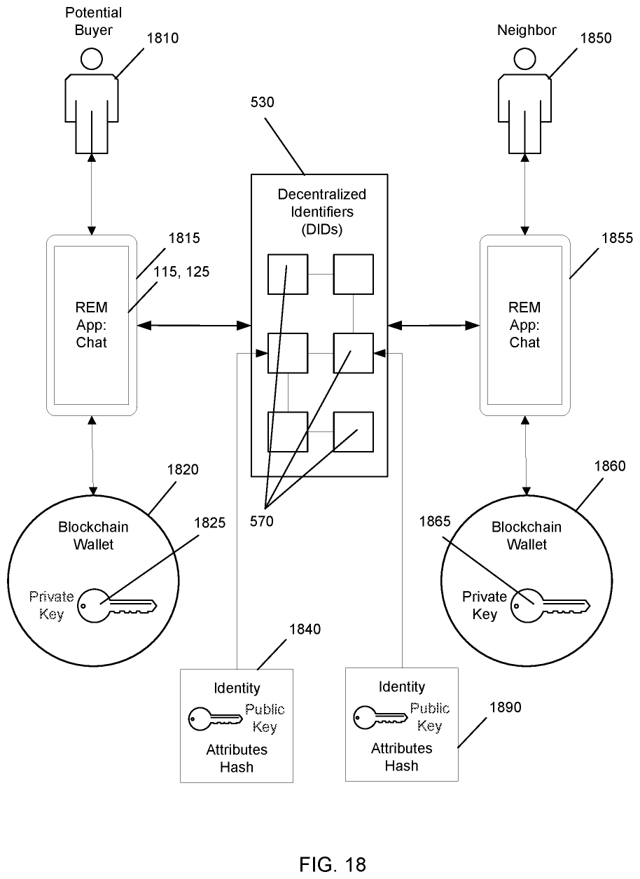

There are several types of users which may be authenticated and verified as further described hereafter to use the system 100, such as admin 610 (FIG. 6), realtor 710 (FIG. 7), potential buyer 1010 (FIG. 10), potential buyer 1510 (FIG. 15), seller 1735 (FIG. 17), owner 1745 (FIG. 17), potential buyer 1810 (FIG. 18), and neighbor 1850 (FIG. 18), each accessing the system via their respective smartphones. An administrator may use a computer 210 (FIG. 2B) to perform system maintenance type functions (e.g., backup a database, add a user, remove a user, start the host server, stop the host server) which do not require a digital wallet.

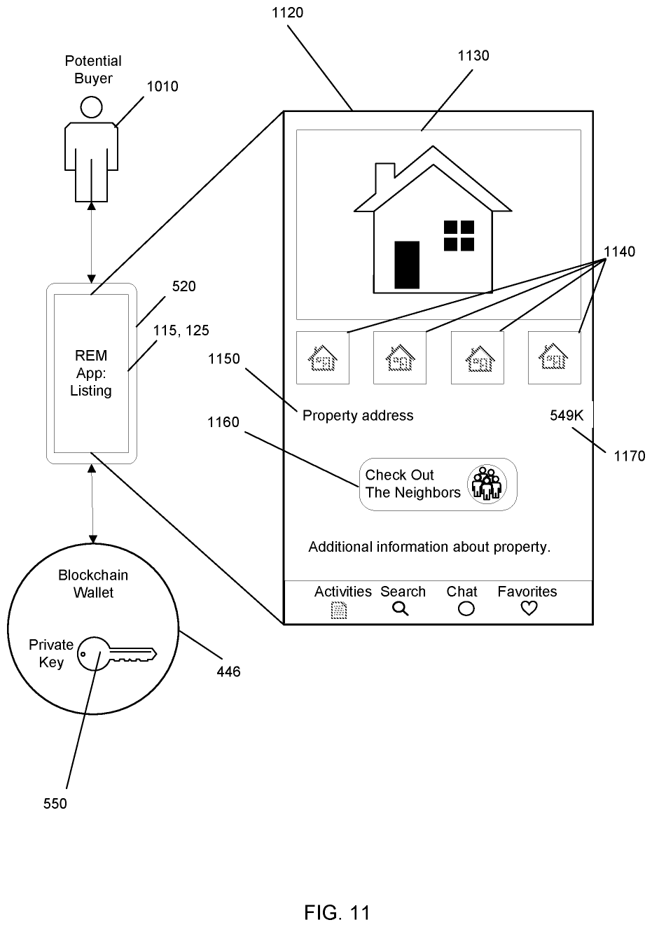

Hereafter, for sake of a more concise presentation, all of the foregoing mentioned users may otherwise be referred to collectively as users 510, since as shown at FIG. 5, for any one of these users to access and use the secure and privatized chat features of system 100 they would each need to be issued a digital wallet 446 maintained on their individual smartphone (e.g., smartphone 110, 120, 520, 1815, 1855) containing a private key 550 and a public identifier block 516 for verification using blockchain nodes 230, 570, which are part of a known decentralized identifier (DID) network 530 accessible via a cellular network/WIFI/Internet 130 regarding a subject property 1130 (FIG. 11) of a specific anticipated real estate transaction.

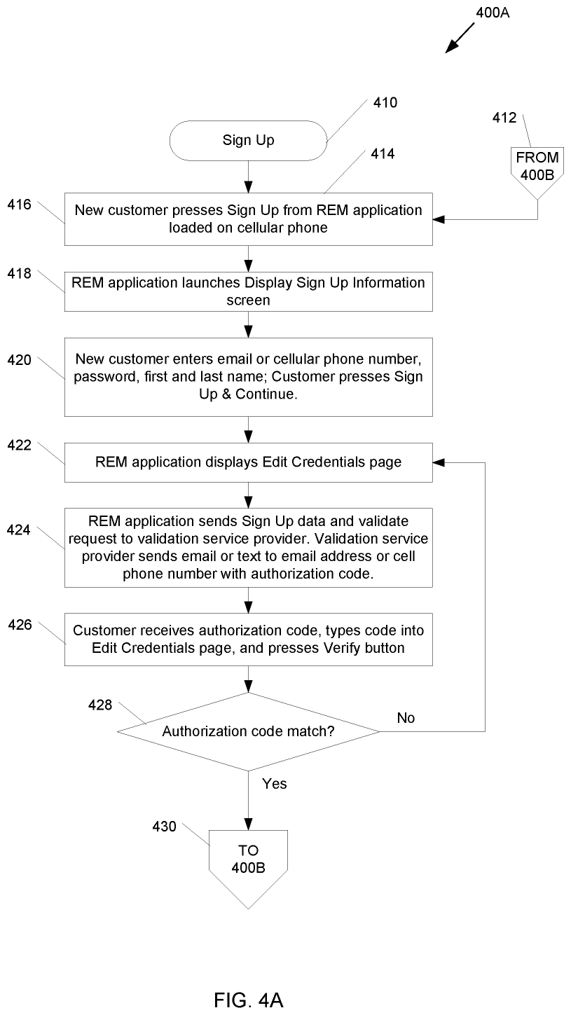

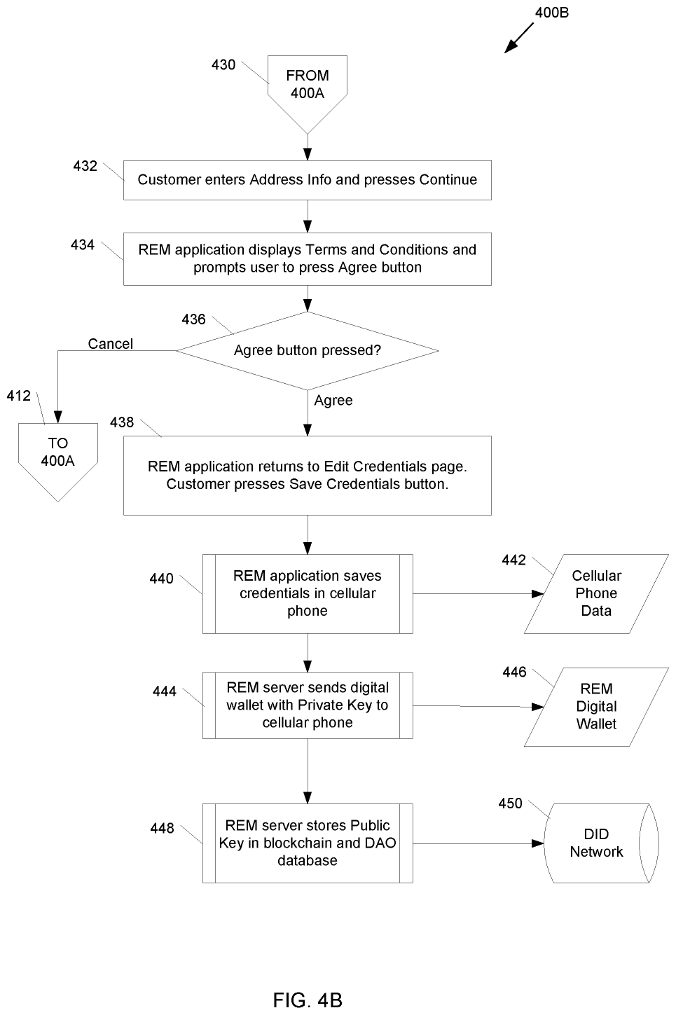

Referring more specifically to FIGS. 1A and 1B, the system 100 comprises: software known as a Real Estate Mobile Application 115, 125 (also referred to herein as the REM Application, or REM App) for download via the cellular/WIFI/Internet network 130 over the Internet to users' mobile smartphones (e.g., smartphones 110, 120). The system 100 comprises a module for enabling registration of users 510 as specified more fully on FIGS. 4A and 4B, thus enabling use and storage of a username and a password for each user and stored at database 310 (FIG. 3) accessible for user login purposes using the users' smartphones (e.g., smartphones 110, 120, 520, 1815, 1855) via the host server system 230. Download of the software application 115, 125 may be accomplished as known via a cellular/WIFI/Internet network 130 from either the Google Play Application Store 140, or the Apple App Store 150, depending on whether the user uses an Android smartphone 110 or an IOS smartphone 120.

As shown in FIG. 2A, there is shown an overview of the system 100 comprising the REM App 115, 125 running on two different smartphones, an Android smartphone 110, and an IOS smartphone 120, respectively, each adapted for communicating via one or more of a cellular network/WIFI/Internet 130. The system 100 is further adapted for managing login via the host computer server system 230, accessing and using the blockchain decentralized identifier (DID) network 530 for confirming the users' 510 identities, and the system is further adapted for accessing and using a known mediator subsystem network 1910 on the Internet, for the receiving and delivery of chat messages (e.g, chat messages 1240, 1730, 1740 (FIG. 17)).

As shown in FIG. 2B, the host server system 230 interfaces with an administrative console PC 210 using Client Side Application JavaScript 220. The host server system 230 also communicates with the REM App 115, 125 running on users' smartphones 110 (Android) or 120 (IOS), respectively, via a known React Native 240 software subsystem via the cellular network/WIFI/Internet 130.

As shown in FIG. 3, the host server system 230 is adapted for managing login by confirming users' usernames and passwords stored in database 310. Further, host server system allows access to stored photographs (stored in database 310) and a customer relationship management (CRM) database 320, which stores subject properties (e.g., 1130 of FIG. 11), users (e.g., 510) and their roles and credentials, activities (e.g., transaction documents, house visit schedules, closing timelines and information, etc.), and potential buyers/buyers, related information. Finally, the host server system 230 interfaces various other tools, or APIs, such as google maps API, react-native API, the DOT loop API, multiple listing service APIs, etc., all as known in the prior art of web systems programming generally.

The flow chart portions 400A and 400B, shown in FIGS. 4A and 4B, respectively, illustrate the signup process, validation of user identities, and upon validation of user identities, the creation of blockchain wallets 446 on users' mobile smartphones (e.g., 110, 120, 520) with corresponding entries into a known distributed ledger on nodes 230, 570 (as shown on FIG. 5, 530 comprises a plurality of nodes, and it is known in the art that there are many such nodes) on the decentralized identifier (DID) network 530, for authenticating users identities.

The registration/signup process begins at 410 of process portion 400A by invoking a signup module 410 which is started when a new customer/user 510 presses Sign Up at 416 using the REM Application loaded on their cellular phone. This launches a Display Sign Up information screen at 418. The user 510 then enters an email address, or phone number, a password, their first and last name, and presses Sign Up & Continue at 420. The REM Application displays an Edit Credentials/login information page at 422, and at 424 the REM Application sends the Sign Up data and a validation request via an application programming interface (API) to a validation service provider, such as Tivoli, and the validation service provider sends an email or text message to the email address, or phone number, respectively, with an authorization code. At 426 the user receives the authorization code, types it into the Edit Credentials/login information page, and they press the Verify button. If at 428 the authorization code matches, control is passed to process portion 400B of FIG. 4B. If not, the REM Application re-displays the Edit Credentials/login information page 422 allowing the user to try again.

At 430, of process portion 400B of FIG. 4B, another module is initiated starting with 432 wherein the user, as part of the registration process, enters their address information (e.g., street address, city, and state) and presses Continue. Thereupon, the REM Application displays terms and conditions and prompts the user to press the Agree button at 434. If the Agree button is not pressed at 436, control returns to 416 (via 412 to 400A) where the user is prompted again to sign up. If the Agree button is pressed at 436, control passes to an Edit Credentials/login information page at 438, wherein the user presses the Save Credentials/User Information button. This causes the REM Application 115, 125 to save the user's Credentials/login information in the user's mobile smartphone cellular phone data repository 442. Thereupon the host server system 230 sends a digital wallet 446 with a private key to the user's 510 mobile smartphone 120, which are saved at 446 in a mobile smartphone data repository. Finally, the host server system 230 stores the user's identity block 516 (comprising the user's public identifier, the user's public key, a plurality of other attributes, and a hash code certifying the validity of the identity block) in the DID network. In this way, the user 510 is now authenticated, so that each time the user logs into the software application they are now authenticated on the DID network using their digital wallet 446, such that the identity of the user is automatically verified each time the user logs into the REM Application 115, 125, thus giving them secure access to chat with other verified users of the REM Application.

As shown in FIG. 5 (illustrating the architecture of the process performed in FIG. 4B), the REM Application 115, 125 of the system 100 enables the creation, use, and storage of a digital wallet 446 (which includes the user's private key) for verification of the user with their public identifier block 516 on the DID network 530 accessible via a cellular network/WIFI/Internet 130 for authenticating users 510 of the REM Application 115, 125 regarding the subject property 1130 of a specific anticipated real estate transaction. This, in turn, enables users to proceed to use the application to do activities, such as search for and research properties for sale, initiate secure chat messaging, issue credentials to users (by realtors), add properties, and to create, send, and receive chat messages with other users of the system pertaining to a subject property of a specific real estate transaction.

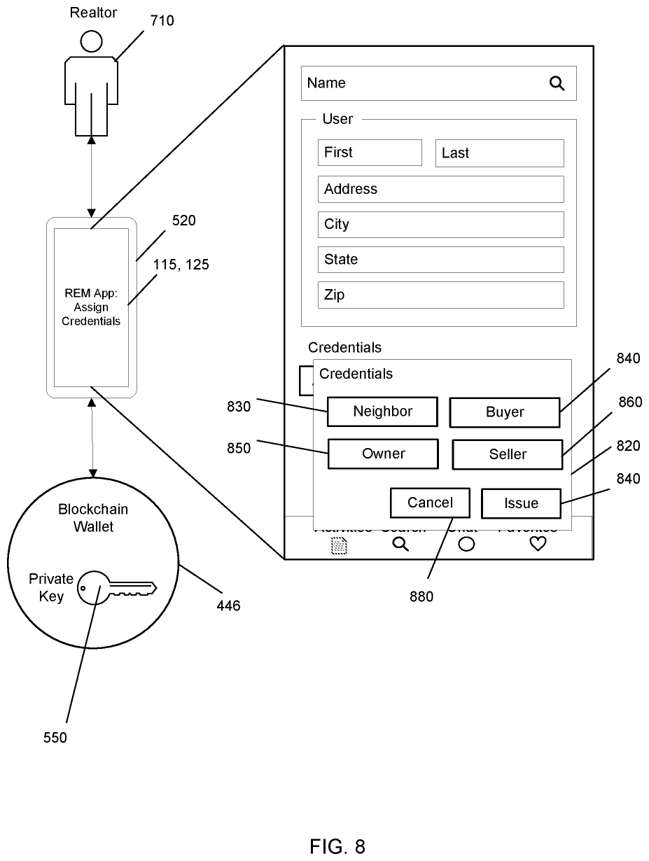

As shown at FIG. 6, an Admin user 610 using the REM Application 115, 125 Manage module on their smartphone 520 is enabled, because of their blockchain wallet 446 with a private key 550 and their Admin role, to enter a user's name or UserID into the REM Application, at search bar 610, whereupon the Admin user is further enabled in user information on screen 620. This, in turn, allows the Admin 610 add a user's role, whether an Admin using checkbox 640, a Broker/Realtor using checkbox 650, a Customer using checkbox 660, and/or a User using checkbox 670. The Broker/Realtor role enables a realtor 710 to associate users 510 later on with particular properties 1120 and to assign users credentials to them, as shown and described further hereinafter in connection with FIGS. 7 and 8.

As shown at FIGS. 7 and 8, the software application 115, 125 comprises another module for enabling realtor users 710, as authenticated on the DID network 530, to issue and revoke credentials to other users 510 in a user information screen 620. Thus, after pressing the Add Credentials button 720, the realtor user 710 is enabled to issue one or more credentials at pop-up window 820 (FIG. 8), such as one or more of, a bona fide neighbor user with button 830, a bona fide owner user with button 850, a bona fide potential buyer user with button 840, and a bona fide seller user with button 860, of the subject property of an anticipated real estate transaction, and each as independently verified by the realtor user. After selecting an appropriate credential(s) for the user, the realtor user 710 then is enabled using button 840 to issue the credential or cancel the process using button 880. Thus, assuming the Admin 610 of FIG. 6 had assigned the role of Broker/Realtor user to realtor 710 by using checkbox 650, the verified realtor 710 (having logged in and having been verified via their blockchain wallet 446 on the DID network 530) is enabled in adding credentials to users 510 using button 720 as previously described. Accordingly, the system 100 provides that the users' credential(s) added or updated in this way are loaded into the users' wallets 446 when they are authenticated to the DID network 530 and they access the mediator network 1910. The outcome of this process is signified with a “Verified” badge when the users' appear to other users in the system 100.

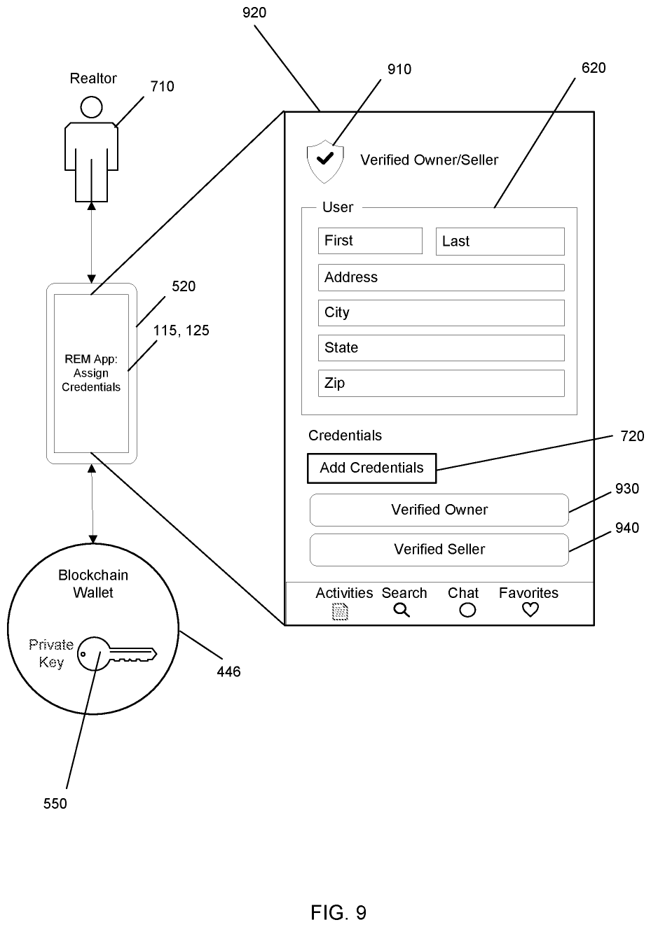

As shown at FIG. 9, once a credential is issued by a realtor user 710, other users are enabled, again by virtue of the credentialed user's blockchain wallet 446 verified on the DID network 530, to see that an issued credential is displayed as a badge, or icon, 910, showing that the credentialed user is, in this case, a bona fide Verified Owner/Seller. This credential means that the realtor has verified the authenticity of the user, for example as a verified owner/seller via their relationship with the user (e.g., they have a listing contract with the user). Credentials may be added or removed via the system 100. Already applied credentials may be viewed and/or removed by selecting which credential applies as shown with buttons 930, 940.

Thus, per FIGS. 7-9, 11, and 17-18, and as part of the authentication subsystem, the system 100 enables realtor users 710 to follow a process to provide credentials to other users' 510 (e.g., a potential buyer 1010, 1510, 1810, a seller 1735, an owner 1745, or a neighbor 1850) digital wallets 446, 1820, 1860, thus confirming to the system, and hence visually confirming to other users associated with a subject property 1130 of a specific real estate transaction, that the user is one of a bona fide potential buyer, a bona fide seller, a bona fide owner, and/or a bona fide neighbor, of the subject property of the specific anticipated real estate transaction. In this way, users of the secure and privatized chat feature of the system are enabled in seeing confirmed assurance of the authenticity of the person they are chatting securely with, and what relationship they have with the subject property.

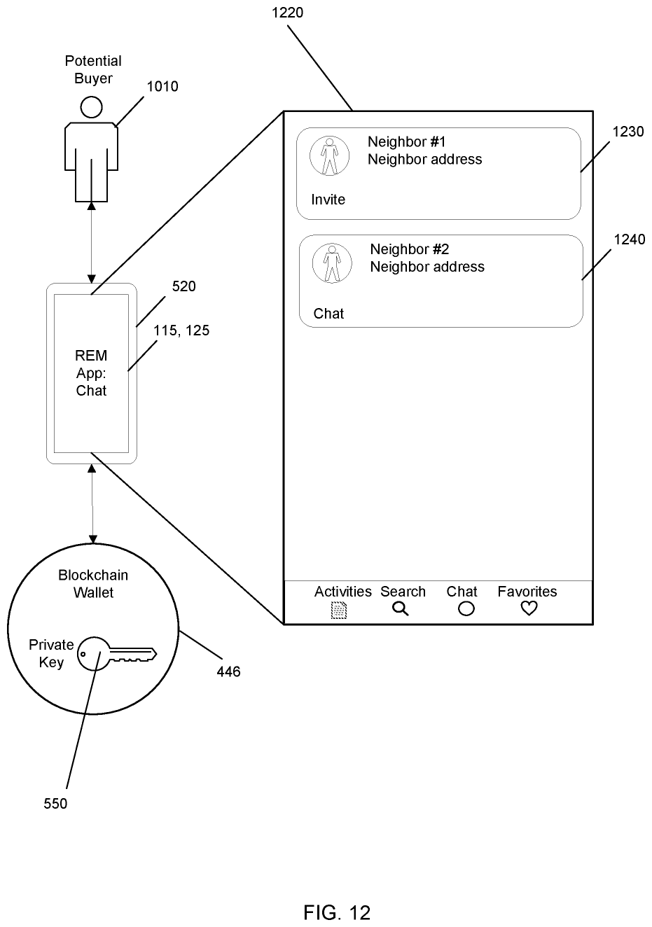

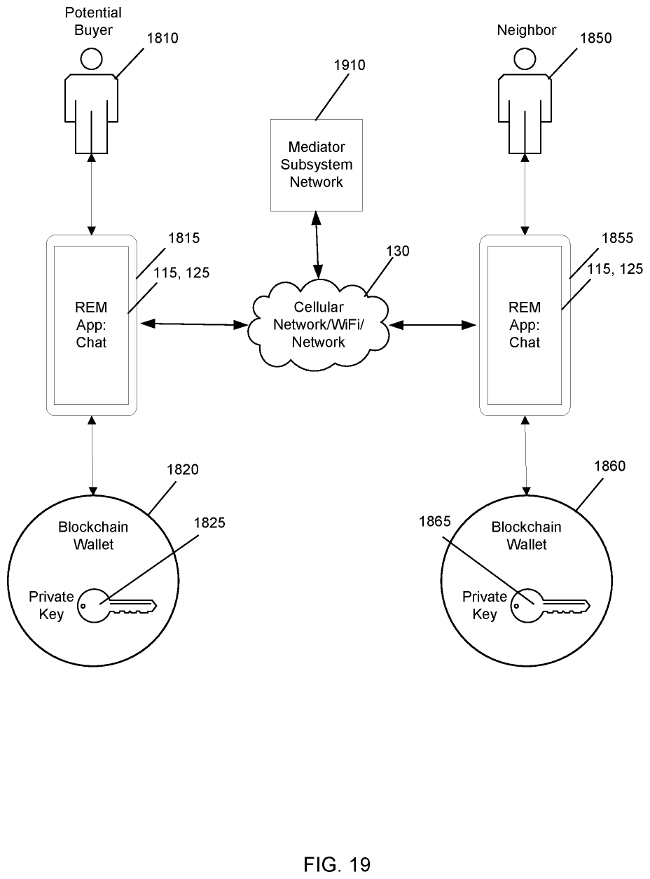

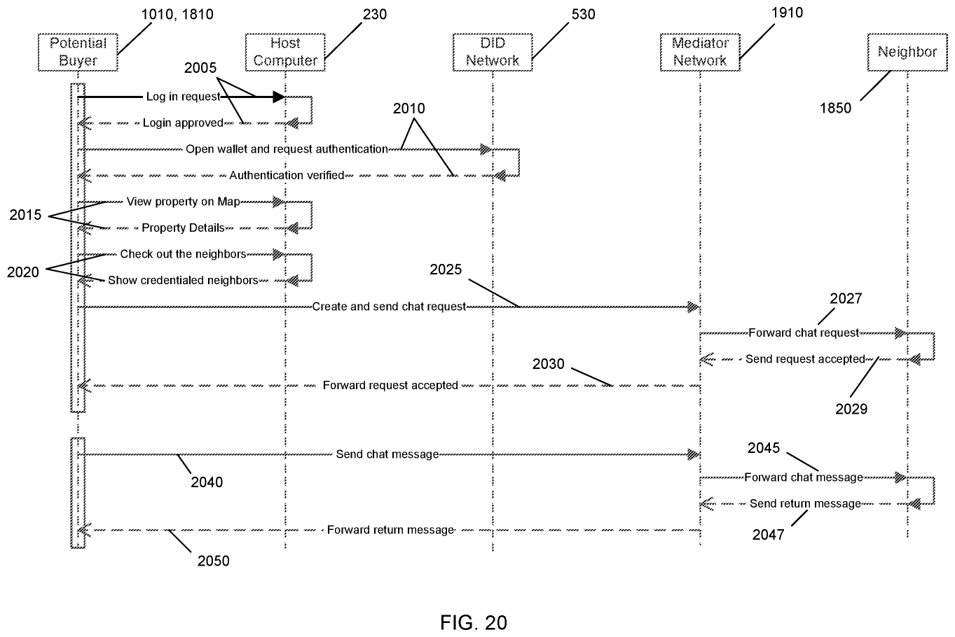

Referring to an example now per FIGS. 10-14, and FIGS. 19-20, the software application 115, 125 comprises a module for enabling the users (e.g., 510, 710, or particularly potential buyer 1010), whether realtor users, neighbors, potential buyers, sellers, or owners, to create chat invites 1230 (see FIGS. 12 and 20), for the users to send/accept the chat invites 2030, 2035, and to thus enable the users to chat peer-to-peer 2040, 2045, 2047, 2050 with one another, wherein the chats are communicated asynchronously via the mediator subsystem network 1910 on the Internet (see FIGS. 19 and 20), and wherein the chats are secured since the users have logged in to the software application 115, 125 on their smartphones and their identities have already been confirmed via their blockchain-secured wallets 446 on the DID network 530 as per FIGS. 4A-5.

FIG. 10 is an illustration of a DID authenticated (as per FIG. 5) potential buyer 1010 (authenticated having used the potential buyer's blockchain wallet and private key 550) enabled to enter an address, zipcode, or MLS number of a property into a search bar 1030, and further enabled with pressing the magnifying glass icon in the search bar to search to see available properties on a map 1080 around the area of the search, together with pricing information 1040, 1050, 1060, 1070 for each possible subject property. As the potential buyer 1010 scans the map 1020 and selects a particular property, the screen is refreshed to display a chosen subject property 1130 as shown in FIG. 11.

FIG. 11 is an illustration of a detailed screen 1120 for a subject property 1130 visible to the DID authenticated (as per FIG. 5) potential buyer 1010 upon clicking on one of the available properties shown in FIG. 10. Upon accessing screen 1120 showing a main photograph of the subject property 1130, and upon being presented with other photographs 1140 of the subject property, the potential buyer is presented with the property address 1150, the listing amount $549K 1170, together with a button 1160 allowing the potential buyer to “Check Out The Neighbors”—i.e., initiate chat messaging with verified bona fide neighbors of the subject property.

Once the “Check Out The Neighbors” button 1160 is pressed, the potential buyer 1010 is brought to a screen 1220 (shown in FIG. 12), wherein the DID authenticated potential buyer 1010 is presented with a chat invite opportunity 1230 with a Neighbor #1, and a chat 1240 already begun with a Neighbor #2. The potential buyer 1010 is then enabled to choose one of these options 1230, 1240, either to invite Neighbor #1 to chat 1230, or to chat with Neighbor #2 1240. Upon pressing button 1230, a chat invite 2025 (see FIG. 20) is sent to the mediator network 1910 (as shown also in FIG. 19), which in turn forwards at 2027 the chat invite to a neighbor 1850 of the subject property for potential acceptance by the neighbor. If the neighbor 1850 accepts the chat request/invite, they send a request accepted message 2029 to the mediator network 1910, which in turn forwards the request accepted at 2030 to the potential buyer's 1810 application 115, 125 on their smartphone 520. Thus, in summary, it may be seen that FIG. 12 is an illustration of a chat screen 1220 visible to the DID authenticated potential buyer 1010 upon clicking on the button to “Check Out the Neighbors”, shown in FIG. 11, allowing the potential buyer to select for chat, or to press another button to invite to chat, with a particular neighbor about the chosen subject property for sale (per FIGS. 10 and 11), the neighbor also having a user account on the system, all as a precursor to obtain valuable and secure information about the subject property for sale before a potential real estate transaction for the chosen property takes place.

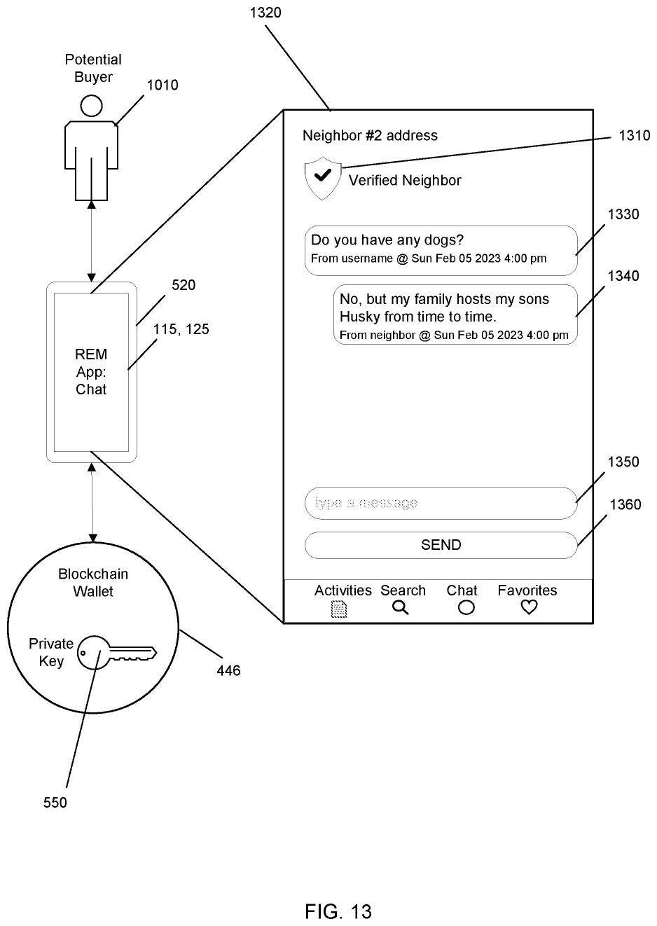

If the DID authenticated potential buyer 1010 selects to chat, or to continue to chat, with Neighbor #2 by selecting button 1240 of FIG. 12, then a chat message screen 1320 per FIG. 13 is displayed showing the neighbor as being verified by the system with icon 1310, whereupon the potential buyer is enabled to type in a chat message 1330 “Do you have any dogs?”, which is sent at 2040 (FIG. 20) to the mediator network 1910 (FIG. 19) for forwarding at 2045 to Neighbor #2 (e.g., 1850 on FIG. 20). Then Neighbor #2 (e.g., 1850 on FIG. 20) is enabled at 2047 to send a return message 1340 (FIG. 13) “No, but my family hosts my son's Husky from time to time”, which is in turn forwarded at 2050 (FIG. 20) to the potential buyer 1810. In this way the authenticated potential buyers (e.g., 1810), and authenticated neighbors (e.g., 1850), are enabled in securely chatting one with another in a secure and private, peer-to-peer, way. Thus, it can be seen that FIG. 13 is an illustration of a chat screen 1320 enabling confidential peer-to-peer communications provided between the potential buyer 1010 and the verified neighbor, Neighbor #2, visible to the DID authenticated potential buyer 1010 as such after having selected the particular neighbor for chat (per FIG. 12), showing the potential buyer that the selected neighbor for chat, Neighbor #2, has been verified by a DID authenticated realtor (per FIG. 8) associated with the property selected on the map (per FIG. 10).

It will be appreciated that these confidential, verified, authenticated chats with parties relevant to a subject property of a potential real estate deal may be considered valuable, for various reasons, to potential buyers, neighbors, sellers, owners, and realtors.

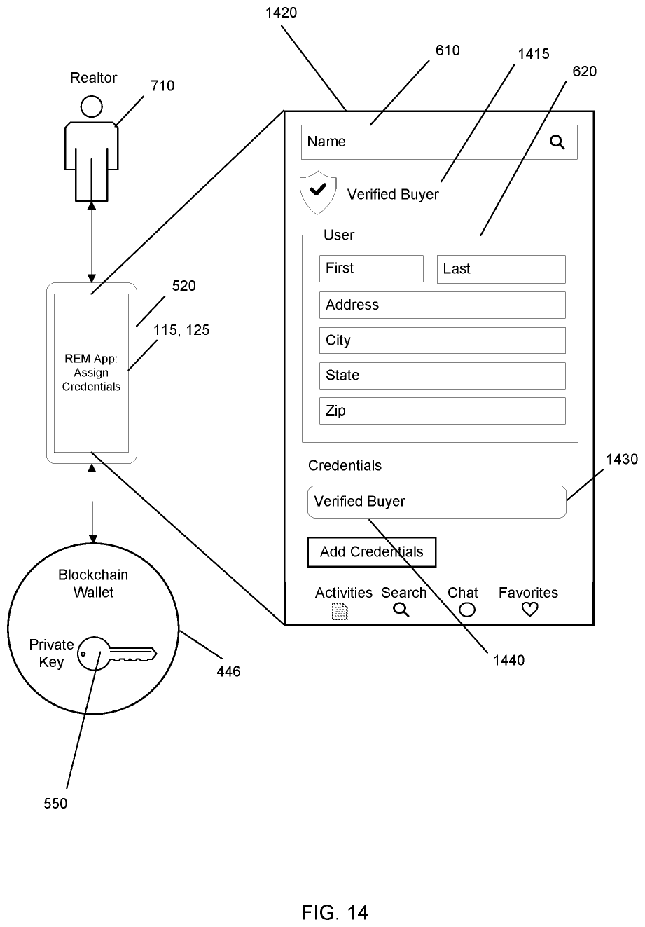

Referring now to FIG. 14, a credential is issued by a realtor user 710 by having pressed the Add Credentials button shown, enabling other users, again by virtue of the credentialed user's blockchain wallet 446 verified on the DID network 530, to see that an issued credential is displayed as a badge 1415, showing that the credentialed user is, in this case, a bona fide Verified Buyer. This credential means that the realtor has verified the authenticity of the user, for example as a verified buyer via their relationship with the user (e.g., they have appropriately qualified the buyer). Once authenticated, each user (e.g., potential buyer 1810) is enabled in chatting as further described below. The verified potential buyer's name and address are also provided on screen 1420, responsive to a search for the buyer user's name by the realtor 710 typed into search bar 610. The realtor 710 is also enabled on screen 1420 in adding, or removing, further credentials by pressing the Add Credentials button 1440 at the bottom of the screen.

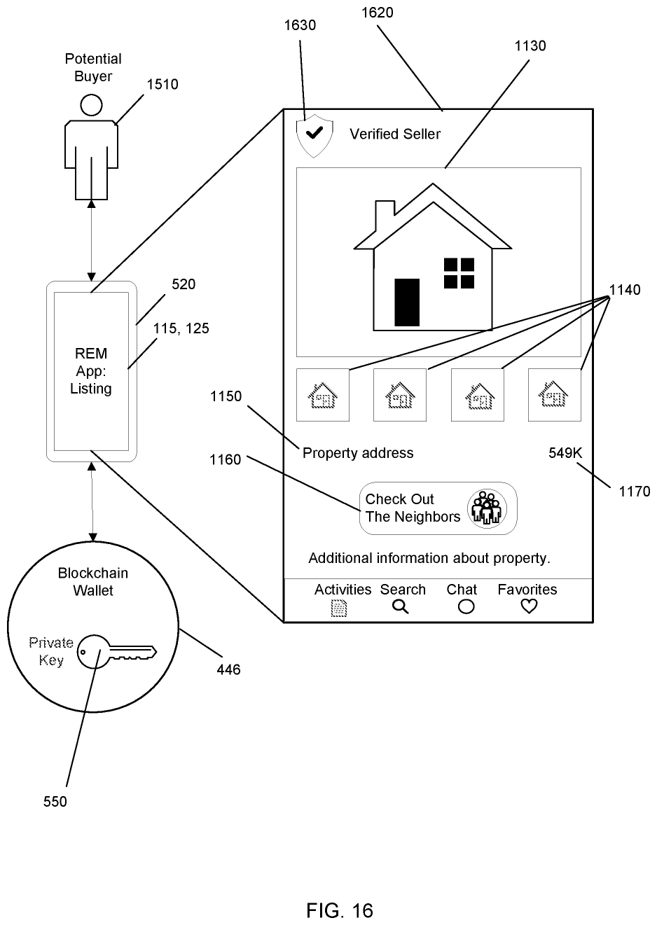

Per FIG. 14, in an aspect and embodiment of the disclosure, the REM App 115, 125 of the system 100 thus enables realtor users 710 to identify, verify, and issue credentials to other users (e.g., potential buyer 1810) relating to a particular real estate transaction and to provide a credential to the potential buyer user's digital wallet 446. This, in turn, confirms to the system, and hence visually confirming to other users associated with the real estate transaction (i.e., in chats with this user), that the user is a bona fide potential buyer, for example, of the subject property (e.g., 1130 of FIG. 16) of the specific anticipated real estate transaction.

Referring now to another example now in FIGS. 15-17, and 20, the software application 115, 125 further comprises yet another module for enabling the users (e.g., 510, 710, 1010, 1510, 1850), whether realtor users, neighbors, potential buyers, sellers, or owners, to create chat invites 2025, 2027 (FIG. 20), for the users to accept the chat invites 2029, 2030, and to thus enable the users to chat peer-to-peer 2040, 2045, 2047, 2050 with one another, wherein the chats are communicated asynchronously via the mediator subsystem network 1910 on the Internet, wherein the chats are secured since the users have logged into the software application 115, 125 on their smartphones, and wherein their identities have already been confirmed via their blockchain-secured wallets 446 on the DID network 530, so they are now free to chat via the mediator subsystem network 1910.

FIG. 15 is an illustration of a DID authenticated potential buyer 1510, using the buyer's blockchain wallet 446 and private key 550, having pressed a filter button 1090 on an REM App 115, 125 map screen 1020 (e.g., as per FIGS. 10, 15) viewable on smartphone 520, allowing the potential buyer to enter and apply specific filters (such as number of bedrooms, baths, square footage, price, etc.) in popup box 1510, enabling showing of only those properties for sale at given prices 1050 shown on the map 1080 of the system 100 and which qualify given the applied filters.

Upon searching with the aforementioned filters applied, and selecting one of the filtered shown properties on the map 1080 per FIG. 15, the DID authenticated potential buyer 1510 is presented with a specific property (e.g., property 1130 shown on screen 1620 in FIG. 16), shown to be offered by a verified seller as indicated at 1630, and made available to the DID authenticated potential buyer 1510. The screen 1620 is able to show the potential buyer 1510 that the property 1130 selected is offered by a seller that is indicated as a Verified seller, meaning that the seller has previously been given credentials by a realtor, as verified independently by the realtor which is also associated with and authenticated by the system 100 (i.e., the realtor is a customer and verified as such by an administrator of the system).

The potential buyer 1510 is also presented with a “Check Out The Neighbors” button 1160, which gives the potential buyer the opportunity to do further research about the subject property 1130, and particularly to invite chats with verified neighbors as shown on FIG. 17 (e.g., with Neighbor #1 at given address by pressing button 1230), to engage in chats with verified neighbors (e.g., Neighbor #2 at given address by pressing button 1240), to engage in chats with the verified seller (e.g., Seller at given address by pressing button 1730), and/or to engage in chats with the verified owner (e.g., Owner at given address by pressing button 1740). Other options along the bottom of the screen 1620, such as an activities button, a search button, a chat button, and a favorites button, all as generally known in the art of mobile smartphone programming, are also provided.

Thus, FIG. 17 is an illustration of a screen made available to the DID authenticated potential buyer after having selected the “Check Out The Neighbors” or chat button at the bottom of the REM App, showing that, in addition to two verified neighbors (Neighbors #1 and 2), a verified seller and a verified owner have been added and are now also available for the chat feature of the REM App 115, 125 on smartphone 520.

FIG. 18 is an illustration of security architecture of the user authentication that takes place to enable one chat user (e.g., a potential buyer 1810), to securely communicate with another chat user (e.g., a neighbor 1850), wherein each chat participant is directly authenticated via blockchain on the DID network 530 (apart from being logged in via the application 115, 125 and host server system 230 as per FIGS. 4A and 20, it also being the case that the application and host server system facilitates/automates accessing of the blockchain on the DID network 530), to provide secure peer-to-peer communication between these two users. Each of the chats described herein is secured and privatized, and may be further encrypted/decrypted, by use of the participants' (e.g., potential buyer 1810, neighbor 1850) blockchain wallets 1820, 1860, respectively, and public identifier blocks 1840, 1890, respectively, on the DID network 530.

FIG. 19 is an illustration of the communications architecture of the secure peer-to-peer chats that take place between the two users (e.g., a potential buyer 1810 and a neighbor 1850) using a mediator subsystem network 1910 on the Internet, after the users have been authenticated via the host server system 230 and via the DID network 530 as described previously herein.

The system 100 facilitates participants in real estate transactions in getting and providing better information that will help buyers, sellers, and owners in making better decisions regarding these important investments. The system 100 can help to bring diverse people together, which in turn, enhances the potential for creativity and success in doing transactions. Thus, the various figures of the specification show various screen shots of the system 100, the REM App 115, 125, flowcharts (FIGS. 4A and 4B) and a Unified Modeling Language (UML) sequence diagram (FIG. 20), showing capabilities, methods of use, system architectures, and other features and benefits made available via the system.

While a preferred embodiment of the present invention has been shown and described, it will be apparent to those skilled in the art having the benefit of the teaching presented in the foregoing descriptions that many modifications may be made to the devices, systems, and methods presented herein, without departing from the invention in its broader aspects. The appended claims are therefore intended to cover all such changes and modifications as fall within the true spirit and scope of the invention.

What is claimed is:

1. A system for enabling secure communications between system users regarding a subject property of a specific anticipated real estate transaction, the system being adapted for accessing and using a blockchain decentralized identifier (DID) network for confirming the users' identities, the system being further adapted for accessing and using a mediator subsystem network on the Internet for the receiving of chat messages and the delivery of chat messages, comprising:
a software application for download to users' mobile smartphones and comprising a module for enabling registration of realtor users and other users, enabling use and storage of a username and a password for each user, and the creation and using of a digital wallet for allowing revocable authentication of users' access to the system using the DID network, wherein said software application further comprises another module for enabling realtor users to issue and revoke credentials to other users as one or more of, a bona fide neighbor, a bona fide owner, a bona fide potential buyer, and a bona fide seller, of the subject property of the anticipated real estate transaction;
a host server computer system having a module for validating the realtor users and the other users' login user identifications and passwords to enable opening of said software application by the users on their mobile smartphones to enable the opening of the users' digital wallets on their mobile smartphones, wherein the module of said host server computer system thereby also enables the realtor users to use the another module of said software application on their mobile smartphones to issue and revoke the credentials;
wherein said software application further comprises yet another module for enabling the users to create chat invites, for users to accept the chat invites, and to thus enable the users to chat peer-to-peer with one another, wherein the chats are communicated asynchronously via the mediator subsystem network on the Internet, and wherein the chats are secured since the users have logged in to the software applications on the users' smartphones and the users' identities have already been confirmed via the users' blockchain-secured wallets on the DID network.

2. The system of claim 1, wherein a user is identified and verified by a realtor provided credential to the user's digital wallet confirming to the system, and hence visually confirming to other users, that the user is a bona fide neighbor of the subject property of the specific anticipated real estate transaction.

3. The secure system of claim 1, wherein a user is identified and verified by a realtor provided credential to the user's digital wallet confirming to the system, and hence visually confirming to other users, that the user is a bona fide potential buyer of the subject property of the specific anticipated real estate transaction.

4. The secure system of claim 1, wherein a user is identified and verified by a realtor provided credential to the user's digital wallet confirming to the system, and hence visually confirming to other users, that the user is a bona fide seller of the subject property of the specific anticipated real estate transaction.

5. The secure system of claim 1, wherein a user is identified and verified by a realtor provided credential to the user's digital wallet confirming to the system, and hence visually confirming to other users, that the user is a bona fide owner of the subject property of the specific anticipated real estate transaction.

6. A method of authenticating users and issuing of credentials pertaining to a subject property of a specific anticipated real estate transaction, the method being adapted for accessing and using a blockchain decentralized identifier (DID) network for confirming the users' identities, comprising the steps of:
providing a software application for users to download and install on their mobile smartphones;
accessing a host server network with a software application module for verifying at least one of a valid email address or a valid phone number of each user;
registering each verified user on a host server computer system;
issuing a blockchain secured digital wallet to each user's smartphone;
creating in the user's digital wallet a revocable authentication for use in verifying a user's identity, enabling granting of trusted status, and replicating the user's public digital identity to be publicly available in the distributed ledger on the DID network; and
enabling issuing of a credential by a realtor user to the digital wallet of another user of one or more of, a bona fide neighbor, a bona fide owner, a bona fide buyer, or a bona fide seller, as to the subject property of the specific anticipated real estate transaction.

7. The method of claim 6, the method further being adapted for inviting secure and privatized chat messaging between the authenticated and credentialed users, the method being further adapted for accessing and using a mediator subsystem network on the Internet for the receiving of chat messages and the delivery of chat messages, further comprising:
enabling creation of a chat request invitation from a first user to a second user;
submitting to the mediator subsystem network the chat request invitation together with the first user's public digital identity and directed to the public digital identity of the second user; and
listening for an acceptance of the request invitation and indicating the second user as available for chat.

8. The method of claim 7, the method further being adapted for receiving and responding to a chat request invitation, between the authenticated and credentialed users, the method being further adapted for accessing and using a mediator subsystem network on the Internet for the receiving of chat messages and the delivery of chat messages, further comprising:
checking the mediator subsystem network, downloading, and displaying any available chat request invitations;
enabling acceptance or denial of a chat request invitation, comprising submitting to the mediator subsystem network the second user's acceptance, together with the second user's public digital identity and directed to the public digital identity of the first user; and
listening for an acceptance of the request invitation and indicating the second user as available for chat.

9. The method of claim 8, wherein peer-to-peer asynchronous chat communication is freely enabled between the first user and the second user on their mobile smartphone software applications.

10. The method of claim 7, wherein the first user's chat invitation request may include the name of the first user.

11. The method of claim 7, wherein the first user's chat invitation request may include the address of the first user.

12. The method of claim 8, wherein the second user's chat acceptance may include the name of the second user.

13. The method of claim 8, wherein the second user's chat acceptance may include the address of the second user.

14. The method of claim 9, wherein messages are secure and privatized using the user's private and public keys.

15. The method of claim 9, wherein the content of the chat messages are encrypted by the private key of the user sending a particular chat message and decrypted by the public key of the user sending the chat message.
